(19) United States
(12) Patent Application Publication
(10) Pub. No.: US 2026/0318339 A1
(43) Pub. Date: Oct. 15, 2026

(54) QUICK-DETACHABLE DEHYDRATION BASKET

(71) Applicant: Jinhua Mingsheng Import and Export Co., Ltd., Jinhua City (CN)

(72) Inventor: Junyan Zhou, Jinhua City (CN)

(21) Appl. No.: 19/296,819

(22) Filed: Aug. 11, 2025

(30) Foreign Application Priority Data
Apr. 14, 2025 (CN) 2025206886931

(51) Int. Cl. F16B 7/04; A47L 13/58

(52) U.S. Cl. CPC F16B 7/0406; A47L 13/58

(57) ABSTRACT

A quick-detachable dehydration basket includes a rod, dehydration basket separable from the rod, and locking component configured to connect the rod and dehydration basket and including a limiting seat and locking seat. The limiting seat is made of a hard material and includes an upper seat and lower seat. The upper seat is smaller than the lower seat in size to form a stepped shape. The lower seat is sleeved on an upper end of the rod and rotatable. The upper seat extends through the dehydration basket, and a stepped surface serves as a dehydration basket supporting surface. Insertion slots are formed in an outer wall of the upper seat, and stoppers are disposed within the insertion slots. The locking seat is sleeved on the upper seat, and a stop lever capable of being inserted on a corresponding stopper is disposed on an inner wall of the locking seat.

### TECHNICAL FIELD

The present disclosure belongs to the field of mop buckets, and particularly relates to a quick-detachable dehydration basket.

### BACKGROUND

Mops are the most commonly used tools for floor cleaning. Cleaning floors with damp, clean mops remains the most environment-friendly and convenient method. After use, the mops typically require rinsing with water. To simplify the cleaning of mops, the prior art has introduced a mop bucket, which commonly adopts a structure with a cleaning bucket on one side and a dehydration basket on the other side. dual-compartment structure. Water is extracted from the mop either by rotating the dehydration basket via a foot pedal linkage or by rotating the dehydration basket which is pivotally secured.

In an existing mop bucket, a rotating shaft and a dehydration basket are locked together, making installation and removal very inconvenient, which affects processing and production efficiency. Additionally, after prolonged use, a significant amount of dirt accumulates inside the bucket body and the dehydration basket. Since the dehydration basket is not easy to detach, thorough cleaning of the bucket body and the dehydration basket becomes difficult, compromising the cleaning quality of a mop. As a result, dehydration baskets that can be detached rapidly have emerged on the market. For example, the Chinese patent No. CN214595775U discloses a mop bucket with a dehydration basket capable of being rapidly disassembled and assembled. The mop bucket includes a mop bucket body and the dehydration basket. The dehydration basket is connected with a rotating shaft of the mop bucket body through a quick disassembly and assembly structure. The quick disassembly and assembly structure includes a limiting sleeve fixed to the dehydration basket, and a clamping sleeve. The rotating shaft is inserted into the clamping sleeve. The clamping sleeve is sleeved within the limiting sleeve and clamps the rotating shaft. From the published document, we can know that the rotating shaft is locked through the insertion fit of the limiting sleeve and the clamping sleeve and rotates under this condition. However, such a design has the following problems: fixation is insecure because, in order to achieve clamping, the clamping sleeve cannot be made of flexible materials such as rubber, which present difficulties in locking the dehydration basket and affect the dehydration effect. If a thin-wall hard material is selected, the fastening effect is not ideal enough. Therefore, this document further discloses the following content: the quick disassembly and assembly structure further includes a locking component which is arranged at the upper end of the limiting sleeve. The locking component is removably mounted at the upper end of the clamping sleeve, and is in threaded connection with the upper end of the clamping sleeve or connected with the clamping sleeve in a snap-fit manner. As can be known from the added content, it is required that the clamping sleeve should be made of a hard material which, however, is prone to deformation in threaded connection. The snap-fit manner can provide additional clamping force, but the clamping mechanism tends to experience reduced fastening effectiveness after prolonged use. Additionally, the structure of locking the rotating shaft with three means is relatively complex. Moreover, the clamping force-based limiting way is only applicable to dehydration baskets with foot pedal linkage mechanisms, as the locking component and the clamping sleeve cannot be used for self-rotating dehydration baskets.

### SUMMARY

In view of the drawbacks of existing quick-detachable dehydration baskets, the technical problem to be solved by the present disclosure is to provide a quick-detachable dehydration basket which is simple and reasonable in structure and capable of effective locking the dehydration basket. Moreover, the quick-detachable dehydration basket also has the advantage of high adaptability to dehydration basket fastening structures.

In order to achieve the above objective, according to one aspect of the present disclosure, the present disclosure is achieved by the following technical measures: A quick-detachable dehydration basket includes a rod, a dehydration basket, and a locking component, the locking component being configured to connect the rod and the dehydration basket and the dehydration basket being separable from the rod, where the locking component includes a limiting seat and a locking seat; the limiting seat is made of a hard material and includes an upper seat and a lower seat; the upper seat is smaller than the lower seat in size to form a stepped shape; the lower seat is sleeved on an upper end of the rod and is rotatable; the upper seat extends through the dehydration basket, and a stepped surface is a dehydration basket supporting surface; a plurality of insertion slots are formed in an outer wall of the upper seat, and stoppers are disposed within the insertion slots; the locking seat is sleeved on the upper seat, and a stop lever capable of being inserted on a corresponding stopper is disposed on an inner wall of the locking seat; and the locking seat is movably fixed to the upper seat by means of the stop lever.

In the quick-detachable dehydration basket, the limiting seat and the locking seat form the locking component, and the plurality of insertion slots are formed in the outer wall of the limiting seat. The stoppers are disposed within the insertion slots. The locking seat is sleeved on the upper seat, and the stop lever capable of being inserted into the stopper is disposed on the inner wall of the locking seat. The locking seat is movably fixed to the upper seat by means of the stop lever. In this way, the dehydration basket can be effectively clamped, avoiding the influence on the dehydration effect due to insufficient clamping force. Moreover, two structures are also very simple. The limiting seat is directly sleeved on the rod such that water can be extracted by rotating the head of a mop.

Further, a bearing is further disposed between the rod and the lower seat. This design allows for increased rotation easiness of the dehydration basket.

Further, the rod and the lower seat are integrally formed, and the rod is driven by an external power device to rotate. This design allows the locking component to directly adapt to a linkage mechanism with a foot pedal and also allows for highly ideal adaptability of the locking component.

Further, a limiting head is disposed at an upper end of the rod, and a limiting hole having a same shape with the limiting head is formed within the lower seat; and the lower seat is limited by means of the limiting hole and the limiting head such that the limiting head and the lower seat rotate synchronously. This design allows for detachment.

Further, the upper seat is round and the lower seat is quadrangular, or both of the upper seat and the lower seat are round.

Further, a rotating head for clamping with a mop holder plate is further disposed at an upper end of the upper seat.

Further, the stopper is a baffle plate arranged transversely, and the stop lever is L-shaped and has a transverse portion inserted between the baffle plate and the insertion slot. This design allows for a simple and ideal structure.

Further, a vertical circular-arc-shaped groove is formed on an outer side of the baffle plate, and an arc-shaped rod clamped in the circular-arc-shaped groove is disposed within an insertion slot on an upper side of the transverse portion. This design allows for further improved locking stability.

Further, an outer wall of the locking seat is designed to be non-slip. This design facilitates tightening and loosening of the locking seat.

Compared with the prior art, the present disclosure has the advantages of a simple and reasonable overall structure, high adaptability of the locking component, and exceptionally stable locking effect for the dehydration basket.

### BRIEF DESCRIPTION OF THE DRAWINGS

The accompanying drawings illustrate exemplary embodiments of the present disclosure, and are intended to explain the principles of the present disclosure together with the description thereof. The accompanying drawings are included to provide a further understanding of the present disclosure, and are included in and constitute part of the specification. In the drawings:

FIG. 1 is a schematic structural diagram of a quick-detachable dehydration basket of the present disclosure;

FIG. 2 is a schematic diagram of an internal structure of a dehydration basket of the present disclosure;

FIG. 3 is a schematic structural diagram of a locking component of the present disclosure;

FIG. 4 is a schematic structural diagram of a limiting seat of the present disclosure; and

FIG. 5 is a schematic structural diagram of a locking seat of the present disclosure.

List of Reference Numerals: 1, rod; 2, dehydration basket; 3, locking component; 4, limiting seat; 5, locking seat; 6, upper seat; 7, lower seat; 8, dehydration basket supporting surface; 9, insertion slot; 10, stopper; 11, stop lever; 12, rotating head; 13, transverse portion; 14, circular-arc-shaped groove; and 15, arc-shaped rod.

### DETAILED DESCRIPTION OF THE EMBODIMENTS

For descriptive purposes, the present disclosure can use spatially relative terms, such as “below”, “below the lower side of”, “under”, “lower”, “on the upper side of”, “upper”, “above”, “higher”, and “side (such as in a “sidewall”)” to describe a relationship (relationships) between one component and another component (other components) as shown in the accompanying drawings. In addition to orientations depicted in the drawings, the spatially relative terms are further intended to include different orientations when a device is in use, operation and/or manufacturing. For example, if the device in a figure is turned upside down, a component described as being “below the lower side of” or “under” another component or feature is then located “above” the another component or feature. Therefore, the exemplary term “below the lower side of” may include orientations “above” and “below”. In addition, the device may be alternatively located (for example, rotated by 90 degrees or in another orientation), thus accordingly explaining spatially relative descriptors used herein.

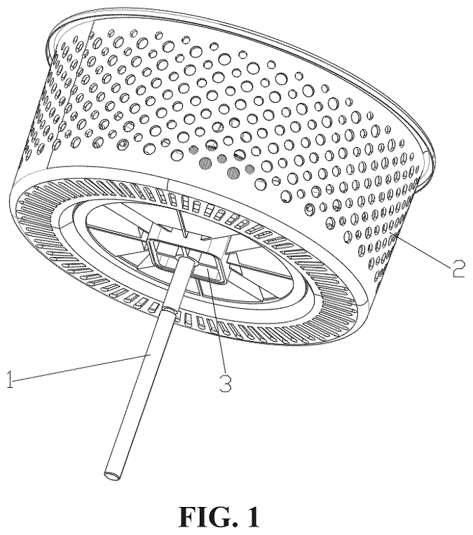

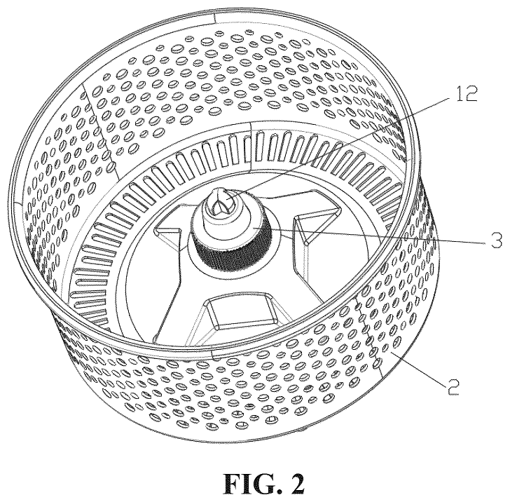

With reference to FIG. 1 and FIG. 2, the present disclosure provides a quick-detachable dehydration basket including a rod 1, a dehydration basket 2, and a locking component 3. The locking component 3 is configured to connect the rod 1 and the dehydration basket 2, and the dehydration basket 2 is separable from the rod 1.

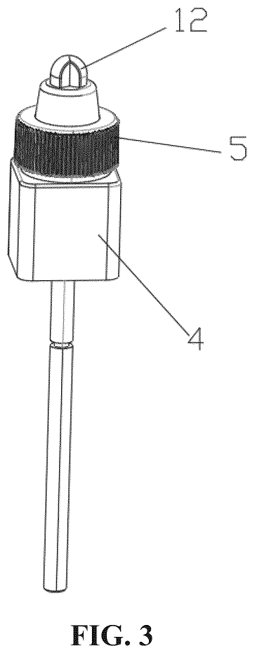

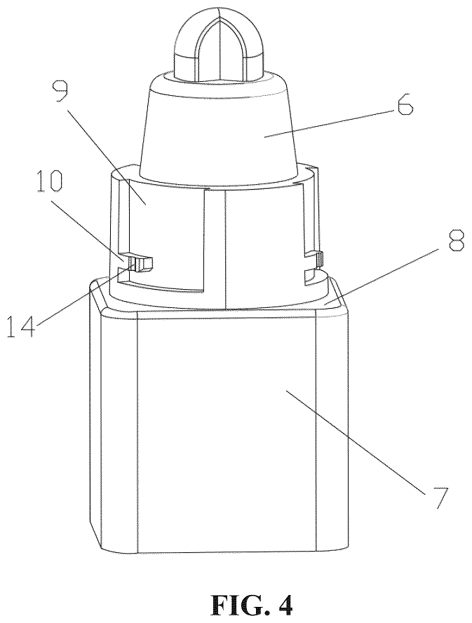

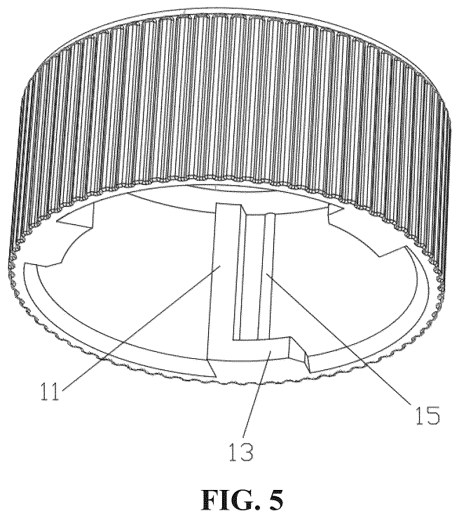

With reference to FIG. 3 to FIG. 5, the locking component 3 includes a limiting seat 4 and a locking seat 5. The limiting seat 4 is made of a hard material and includes an upper seat 6 and a lower seat 7. The upper seat 6 is smaller than the lower seat 7 in size to form a stepped shape. The lower seat 7 is sleeved on an upper end of the rod 1 and is rotatable. The upper seat 6 extends through the dehydration basket 2, and a stepped surface is a dehydration basket supporting surface 8. A plurality of insertion slots 9 are formed in an outer wall of the upper seat 6. The insertion slots 9 are arranged in a circular array on the outer wall of the upper seat 6. Stoppers 10 are preferably disposed within the insertion slots 9. The stopper 10 is a baffle plate arranged transversely. The locking seat 5 is sleeved on the upper seat 6, and a stop lever 11 capable of being inserted on a corresponding stopper 10 is disposed on an inner wall of the locking seat 5. The stop lever 11 is L-shaped. A transverse portion 13 of the stop lever 11 is inserted between the stopper 10 and the insertion slot 9 such that the locking seat 5 is movably fixed to the upper seat 6. Moreover, a vertical circular-arc-shaped groove 14 may also be formed on an outer side of the baffle plate, and an arc-shaped rod 15 clamped in the circular-arc-shaped groove 14 is disposed within the insertion slot 9 on an upper side of the transverse portion 13. Thus, the dual-locking design further allows for a significantly improved locking effect.

As a preferred structure, a bearing is further disposed between the rod 1 and the lower seat 7.

As a preferred structure, the rod 1 and the lower seat 7 may also be integrally formed, and the rod 1 is driven by an external power device to rotate. In this way, direct adaptation to a foot pedal linkage mechanism is enabled. Of course, the upper end of the rod 1 may be designed into a quadrangular limiting head, and a limiting hole having a same shape with the limiting head is formed within the lower seat 7. The lower seat 7 is limited by means of the limiting hole and the limiting head such that the limiting head and the lower seat rotate synchronously.

As a preferred structure, the upper seat 6 is round and the lower seat 7 is quadrangular, or both of the upper seat 6 and the lower seat 7 are round.

As a preferred structure, a rotating head 12 for clamping with a mop holder plate is further disposed at an upper end of the upper seat 6. In this way, the mop disk may rotate smoothly. Furthermore, the outer wall of the locking seat 5 is designed to be non-slip.

In the description of this specification, the description of the terms “one embodiment/implementation”, “some embodiments/implementations”, “example”, “specific example”, or “some examples” means that the specific features, structures, materials, or characteristics described with reference to the embodiment/implementation or example are included in at least one embodiment/implementation or example of the present disclosure. In this specification, the illustrative expressions of the above terms are not intended to refer to the same embodiment/implementation or example. Moreover, the specific features, structures, materials, or characteristics described may be combined in any suitable manner in any one or more embodiments/implementations or examples. In addition, those skilled in the art may combine different embodiments/implementations or examples described herein or features in different embodiments/implementations or examples without any contradiction.

In addition, the terms “first” and “second” are merely intended for a purpose of description, and shall not be understood as an indication or implication of relative importance or implicit indication of a quantity of indicated technical features. Therefore, a feature limited by “first” or “second” may explicitly or implicitly include at least one such feature. In the description of the present disclosure, “a plurality of” means at least two, such as two or three, unless otherwise clearly and specifically limited.

Those skilled in the art should understand that the foregoing implementations are merely intended to describe the present disclosure clearly, rather than to limit the scope of the present disclosure. Those skilled in the art may make other changes or modifications based on the foregoing disclosure, but these changes or modifications should fall within the scope of the disclosure.

What is claimed is:

1. A quick-detachable dehydration basket, comprising: a rod, a dehydration basket, and a locking component, the locking component being configured to connect the rod and the dehydration basket and the dehydration basket being separable from the rod, wherein the locking component comprises a limiting seat and a locking seat; the limiting seat is made of a hard material and comprises an upper seat and a lower seat; the upper seat is smaller than the lower seat in size to form a stepped shape; the lower seat is sleeved on an upper end of the rod and is rotatable; the upper seat extends through the dehydration basket, and a stepped surface serves as a dehydration basket supporting surface; a plurality of insertion slots are formed in an outer wall of the upper seat, and stoppers are disposed within the insertion slots; the locking seat is sleeved on the upper seat, and a stop lever capable of being inserted on a corresponding stopper is disposed on an inner wall of the locking seat; and the locking seat is movably fixed to the upper seat by means of the stop lever.

2. The quick-detachable dehydration basket according to claim 1, wherein a bearing is further disposed between the rod and the lower seat.

3. The quick-detachable dehydration basket according to claim 1, wherein the rod and the lower seat are integrally formed, and the rod is driven by an external power device to rotate.

4. The quick-detachable dehydration basket according to claim 3, wherein a limiting head is disposed at an upper end of the rod, and a limiting hole having a same shape with the limiting head is formed within the lower seat; and the lower seat is limited by means of the limiting hole and the limiting head such that the limiting head and the lower seat rotate synchronously.

5. The quick-detachable dehydration basket according to claim 1, wherein the upper seat is round and the lower seat is quadrangular, or both of the upper seat and the lower seat are round.

6. The quick-detachable dehydration basket according to claim 1, wherein a rotating head for clamping with a mop holder plate is further disposed at an upper end of the upper seat.

7. The quick-detachable dehydration basket according to claim 5, wherein a rotating head for clamping with a mop holder plate is further disposed at an upper end of the upper seat.

8. The quick-detachable dehydration basket according to claim 1, wherein the stopper is a baffle plate arranged transversely, and the stop lever is L-shaped and has a transverse portion inserted between the baffle plate and the insertion slot.

9. The quick-detachable dehydration basket according to claim 8, wherein a vertical circular-arc-shaped groove is formed on an outer side of the baffle plate, and an arc-shaped rod clamped in the circular-arc-shaped groove is disposed within an insertion slot on an upper side of the transverse portion.

10. The quick-detachable dehydration basket according to claim 1, wherein an outer wall of the locking seat is designed to be non-slip.

11. The quick-detachable dehydration basket according to claim 9, wherein an outer wall of the locking seat is designed to be non-slip.
